(19) United States
(12) Patent Application Publication
(10) Pub. No.: US 2005/0234869 A1
(43) Pub. Date: Oct. 20, 2005

(54) Verification system for dry cleaners and the like

(76) Inventor: Paul E. Massod, Brockton, MA (US)

Correspondence Address: FISH & RICHARDSON PC, P.O. BOX 1022, MINNEAPOLIS, MN, 55440-1022, US

(21) Appl. No.: 11/057,700

(22) Filed: Feb. 14, 2005

Related U.S. Application Data
(63) Continuation of application No. 09/334,574, filed on Jun. 21, 1999, now abandoned.

(51) Int. Cl. G06F 17/30

(52) U.S. Cl. 707/2

(57) ABSTRACT

An apparatus for verifying inventory grouping comprises a scanner to scan codes on labels, and a computer having a computer readable storage media storing a computer program product. The product includes instructions for causing the computer to verify that articles in a grouped order belong in the grouped order by examining codes on tags associated with each article in the group to determine that the article belongs in the group. Most dry cleaning establishments have built up over the years efficient ways to manually assemble garment articles into orders. This invention capitalizes on that investment. Rather than throwing away an established manual system to regroup, this invention establishes a verification system that can catch the infrequent but costly regrouping mistakes that occur.

### BACKGROUND

This invention relates to inventory systems particularly adapted for dry cleaning establishments.

Manual assembly or grouping techniques are used to assemble groups of orders for dry cleaning establishments. In the typical manual method a worker examines a tag on a garment and manually places it on an assigned hook in an assembly station. The establishment can have an assembly station with a certain number of hooks. The worker matches a number on the tag or invoice to one of the hooks that was assigned to the number. Thus if a garment has a tag with number “185” the worker will place the garment on the hook that was assigned to number “185.”

Automated systems to assemble or group pieces of an order are known. These assembly systems have an arrangement of pairs of lights. Typically, one light of the pair indicates what group to place an article in whereas, the other light indicates when the group has been completed. In such systems each pair of lights are associated with corresponding one of a plurality of assemble stations or hooks used to hold the garments during a grouping operation. A bar code reader is coupled to a computer system that controls the lights. In operation a batch of cleaning may involve a number of orders. The system is designed such that invoices and associated tags are coded e.g., by bar codes to the orders. Each one the lights is assigned to a group, and as the tag is scanned a light will go on to indicate the rack on which to place the garment. Thus, if the system has thirty pairs of lights and associated assemble hooks it can process for grouping thirty orders. In general the system needs one light pair for each order.

### SUMMARY

Rather than using an expensive apparatus to regroup items this invention is directed to an apparatus and method to verify that grouping was done correctly, whether grouping was done manually or by an automated process. A large dry cleaning operation may have several people doing assembly. An automated grouping system could provide improvements in speed and accuracy and save on needed labor. For most dry cleaning operations this is not a great advantage. Most dry cleaning establishments are small having one or at most two people doing assembly. Therefore, the typical dry cleaner has would not save on labor with an automated grouping system.

According to an aspect of the present invention, a method of inventory management comprises verifying that the articles in a grouped order belong to the grouped order, wherein verifying includes examining codes on tags associated with each article in the group to determine that the article belongs in the group.

According to a further aspect of the present invention, a computer program product resides on a computer readable media. The product is for use in a dry cleaning establishment and comprises instructions for causing a computer to verify that articles in a grouped order belong in the grouped order by examining codes on tags associated with each article in the group to determine that the article belongs in the group.

According to an additional aspect of the invention, an apparatus for verifying inventory grouping comprises a scanner to scan codes on labels, and a computer having a computer readable storage media storing a computer program product comprises instructions for causing the computer to verify that articles in a grouped order belong in the grouped order, wherein instructions to verify further comprise instructions to examine codes on tags associated with each article in the group to determine that the article belongs in the group.

One or more of the following advantage may be provided by one or more aspects of the present invention.

Most dry cleaning establishments have built up over the years efficient ways to manually assemble garment articles into orders. There are many ways to manually assemble. Small dry cleaners in particular have made a substantial investment in the manual systems that they use. This invention capitalizes on that investment. Rather than throwing away an established manual system to regroup, this invention establishes a verification system that can catch the infrequent but costly regrouping mistakes that occur. Although of particular advantage with manual systems, especially for operations of the size that can not take advantage of any savings in labor in the automated system, it would also be useful for automated systems.

### BRIEF DESCRIPTION OF THE DRAWINGS

FIG. 1 is a diagrammatical view of a dry cleaning establishment including a item grouping verification system.

FIG. 2 is a block diagram of the verification system used in FIG. 1.

FIG. 3 is a diagrammatical view of a garment tag having a unique identification imprinted as a bar code and alpha-numeric.

FIG. 4A-4C are flow charts of a verification process used in the verification system of FIG. 2.

### DESCRIPTION

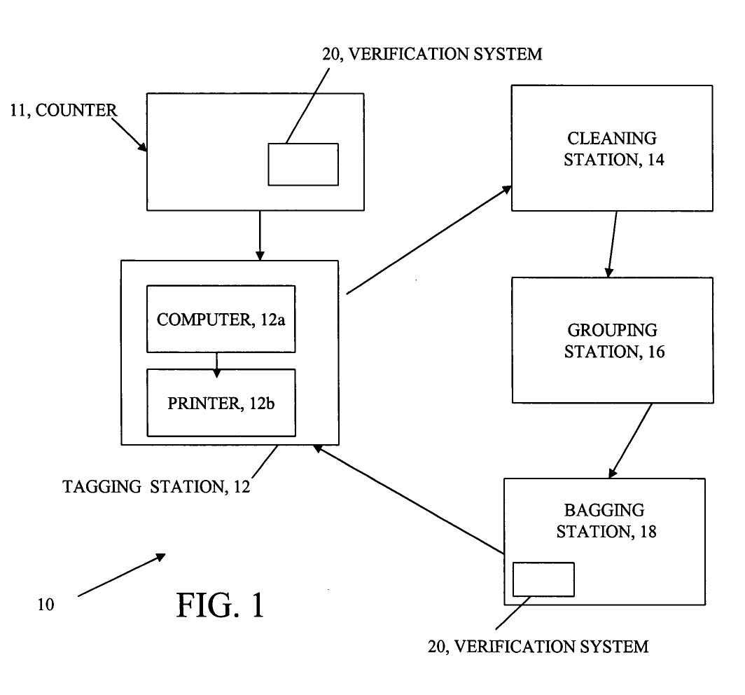

Referring to FIG. 1, a dry cleaning establishment 10 includes a front counter 11 where garments for cleaning are given to the establishment and the customer receives an invoice or claim ticket. The establishment 10 also includes a tagging station 12 where tags that are used to track the garment are produced and placed on the garments. The tagging station 12 includes a control device such as a computer system 12a for entering information concerning a transaction. The information that can be entered includes identification information that identifies the customer associated with the transaction, as well as information concerning the nature of the transaction. For example, information includes the number of pieces or articles that make up the transaction and which will be grouped together at the end of a cleaning process. Optionally, the information could also include short descriptions for the articles.

The tagging station 12 also includes a printer 12b to optionally print a transaction receipt, and to print tags on demand that will be affixed to the articles. The printer can be a dot matrix, thermal transfer, ink-jet, or laser type printer. The tags include unique sequential indicia that include a group id associated with the transaction or customer, and a unique sequence number. The establishment 10 also includes a cleaning station 14 which may be local to the establishment 10, or an offsite central location that receives batches of garments for cleaning from drop stores.

The dry cleaning establishment 10 also includes a grouping station 16 and a bagging station 18. Often cleaning is actually performed in lots or batches that may include several different groups or customer orders. The bagging station 18 based on the productivity of the establishment can either be part of the grouping station 16 or separate from the grouping station 16. The bagging station 18 includes a verification system 20. The verification system 20 could alternatively be located at the front counter 11 to be implemented at payment or where the dry cleaning establishment 10 has a final check that the initial sorting was done properly. The tags can either be left on the garments or they can be removed and attached to an invoice.

At the grouping station 16, the dry cleaning establishment 10 can manually assemble an order or can use one of the automated systems. At the bagging station 18, a bag e.g., a plastic bag, is placed over the clothes. At this point, the dry cleaning establishment 10 considers that the customer's order has been assembled and all the items in the group belong to that customer. Racked means that it is ready for pick-up on a conveyor or a slick rail where a customer can walk into the store and request that a clerk give him the order.

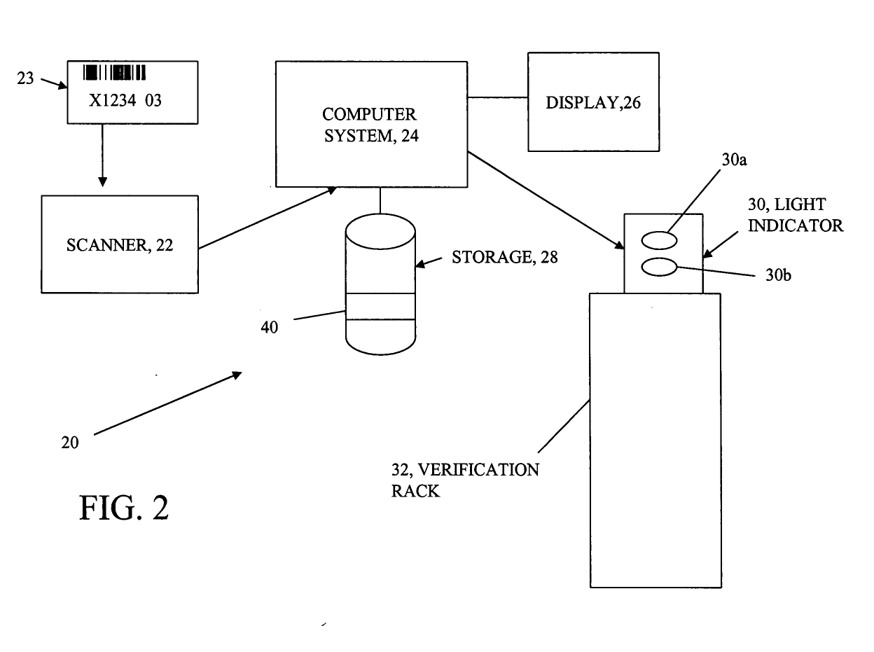

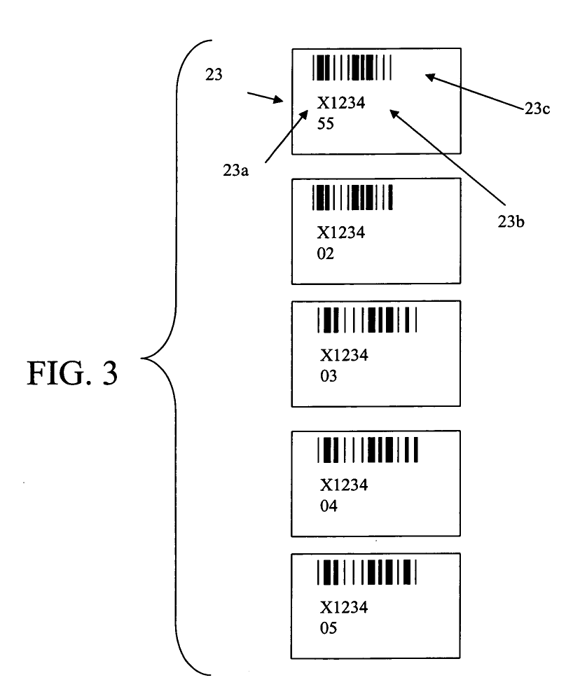

Referring now to FIG. 2, the verification system 20 includes a scanner 22. The scanner 22 could be a bar code scanner, having a wand or the like, (not shown) a radio frequency tag identifier scanner, a touch memory type of scanner, or optical character recognition (OCR) device. The scanner 22 reads the code on the tag. The code can be anything that would be machine readable such as bar codes, touch memory devices, or radio frequency type devices or maybe an optical character recognition (OCR) code format. The scanner 22 is used to read a garment tag 23. The garment tag 23 (further described in FIG. 3) could be a permanent label, a put on/take off reusable label or it could be a one-time use paper label.

The verification system 20 operates on an order which was assembled either by an automated system or in most cases, manually assembled. The verification system 20 also includes a computer system 24 having a display device 26 and hard disk storage 28. The computer system 24 would also include a memory and input/output interfaces (not shown). The computer system 24 receives data from the scanner 22 and executes a verification process 40 (described in FIG. 3) stored as a computer program on the storage device or which could also be implemented as a firmware process in a specialized controller. The computer system also produces signals that control a display indicator such as the display 26 or a light indicator system 30.

The verification system 20 is used to verify that the grouping i.e., manual or automated assembly, was correct. The verification system 20 includes an indication device such as a display 26 and/or the light indicator system 30. Alternatively, an audio system (not shown) could be used. The indication device, e.g., the light indicator system 30 is used to indicate that the order is correctly grouped or that one or more pieces in the order are missing or were incorrectly grouped into the order.

The light indicator system 30 includes two different indicators 30a and 30b, each preferably being a different color. One indicator 30a is used to indicate that articles are properly in the order and the other 30b is used to indicate a misplaced article or incorrect article in the order. To start the process an operator would scan either one of the garment tags 23 or the invoice itself, both having some machine readable code. The light indicator system can be disposed on or adjacent to a slick rail 32 that holds grouped items such as garments.

If the scan starts with the information on the garment tag 23 the computer can assess a database to determine identification information regarding the order. If the invoice is scanned the invoice can identify the order. In some instances the invoice might not be present when the scan in the verification system 20 is made particularly where dry cleaning is done at a main plant and orders are delivered to satellite or drop stores where the invoice might be kept. Thus, at the main plant the invoice might not be available to match up with the order, but the garment tags 23 are available. By a drop store is meant a store that accepts orders but contracts with or is associated with a centralized dry cleaning facility that actually does the dry cleaning for many store outlets. Thus, the garments may be assembled and verified at the main plant. The main plant would send finished and assembled orders back to the drop stores. Alternatively, ungrouped articles in batches of garments from many different orders (groups) could be sent back to the drop stores for manual grouping and verification.

Referring now to FIG. 3, the verification system 20 can use any type of code. One type of code that would be preferred is a code that includes information about the invoice, number of articles in an order, and uniquely identifies each article in the order. As shown in FIG. 3, the garment tag 23 has a code that includes a group_ID 23a, a sequence_ID 23b and a machine readable bar code 23c that encodes both the group_ID 23a and the sequence_ID 23b. The illustrated bar code is diagrammatic only. As drawn it is not intended to actually correspond to the alpha-numeric provide thereunder. However is an actual system the bar code would correspond to the encoded alpha-numeric in a machine readable format.

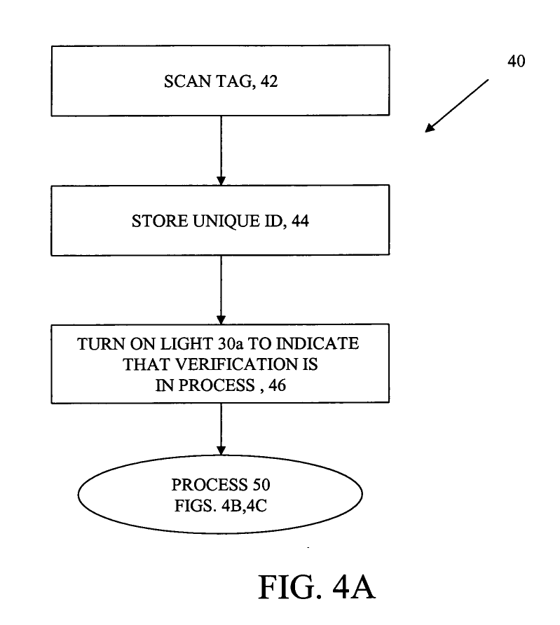

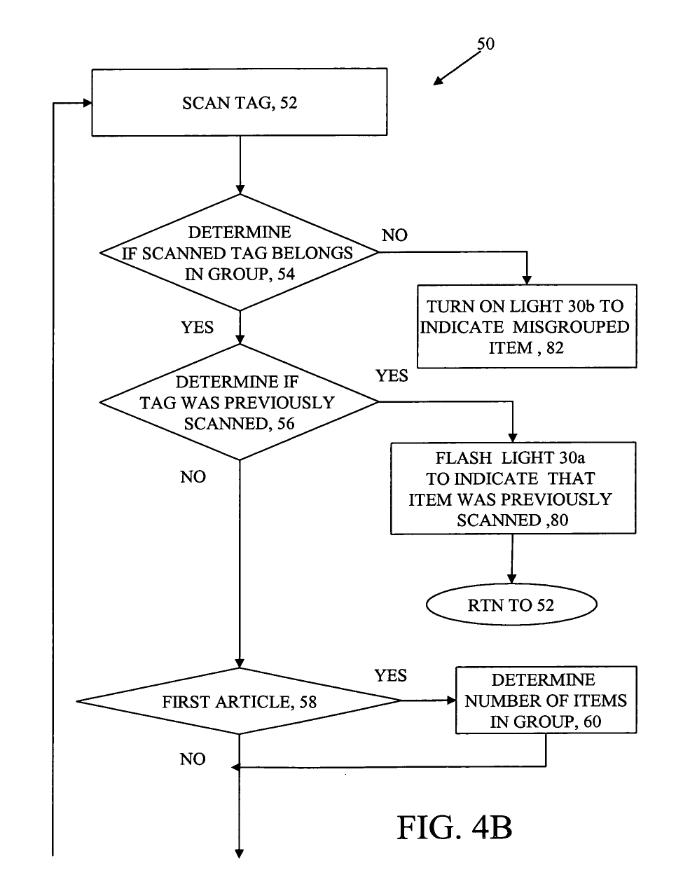

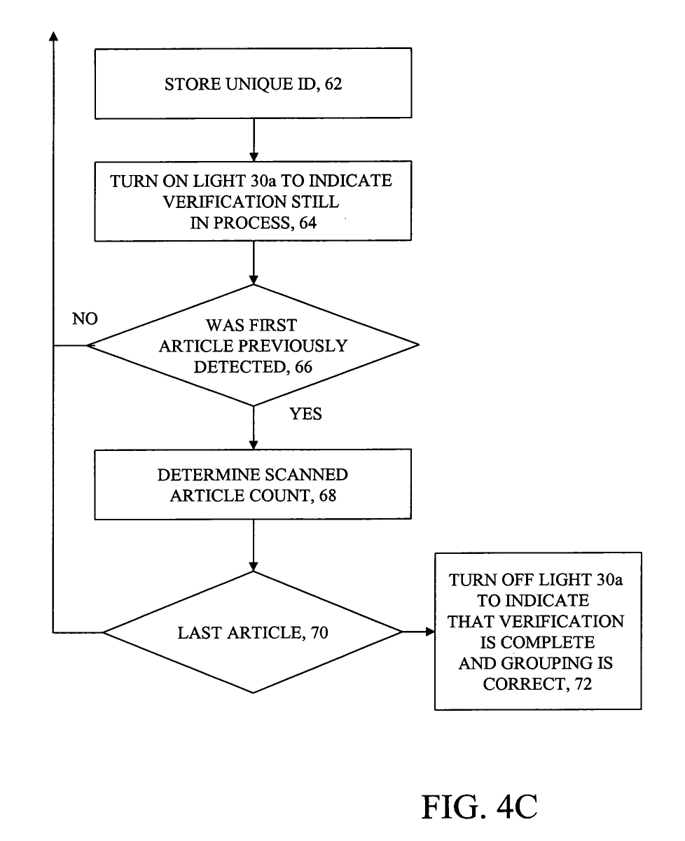

This code obviates the need to access a database for each item since it includes a unique_ID for each item and the total number of items in the group. The code includes the group_ID number 23a e.g., “X1234” to which is concatenated the sequence_ID 23b “55.” The sequence_ID 23b for the first article is an encoded sequence that encodes the number of articles in the group. The encoded sequence 23b is a number that is the total number of pieces in the order plus “50.” If the order has five pieces, the first piece number is 55, as shown. The unique_ID would be “X1234 55.” Subsequent tags belonging to that order would have unique numbers “X1234 02”, “X1234 03”, and so forth as shown. However, other coding schemes with minor modifications to the process 40 (FIGS. 4A-4C) could be used.

This verification system 20 allows verification of orders up to 50 pieces. If the sequence number is greater than 50, it indicates that the tag corresponds to the first piece in the order. When 50 is subtracted from the last two digits, the answer is the number of pieces in the order. Thus for an order of one piece, the number would be 51, for five pieces, the number would be 55, and so forth. By scanning the unique_ID verification is performed without the need to access the database or have a database anywhere local to the garment. By using this arrangement it obviates the need to look up in a database to find the number of items in an order. This provides a stand alone verification capability and allows operation from the information on the garment tag 23 or invoice for verification.

Referring now to FIG. 4A, the verification process 40 starts by an operator scanning 42 an invoice ticket or a garment tag 23. The verification process 40 receives and stores 44 the group_ID and encoded sequence number from the garment tag 23 or ticket that was scanned. The verification system 20 could cause the yellow light to turn on 46 indicating that verification of an order is in process.

Referring to FIGS. 4B-4C, the operator can scan 52 a tag on a second garment. The process 40 will examine 54 the group_ID on the second tag and if the second garment belongs in the group, i.e., the group numbers are the same, and was not previously scanned 56 it will determine 58 if it is the first article in the group. If it is the first article in the group the process 40 will determine 60 the number of articles in the group. If it is not the first article,.the process 40 stores 62 the group_ID and encoded sequence number from the garment tag 23 or ticket that was scanned. The verification system 20 could cause the yellow light to remain on 64 indicating that verification is still in process and that the garment tag belonged in the group. If the process 50 determines 66 that the first article was previously scanned it will determine 68 the scanned article count and determine 70 if it is the last article. If it is the last article it will turn off 72 light 30a indicating that the verification process is complete. If it was not the last article it will return to 52 to await the scanning of the next article.

If the process 50 determines 54 that the same item was scanned twice, e.g., through operator fault, (the operator was distracted or left to do something else and came back and did recall whether the item had been scanned) the process 50 will cause the yellow light 30b to flash 80 or another indication could be used to signify that it was a repeat scan. In any event, the verification system 20 would not count the duplicate scanned item as part of the group. This allows the operator to leave the operation. The verification system 20 provides a visual indicator that can be displayed on the computer screen or could produce an audio output to indicate to the operator that the item had already been scanned but that the item is the correct group.

As mentioned above, if the group is correctly assembled after the last item in the group has been scanned, the yellow light goes out. Turning off of the yellow light indicates that the order is now machine verified and correct. If, during the process 50 it is determined 54 that the tag which was scanned does not belong in the order, the verification system 20 causes 82, e.g., light 30b to flash. Light 30b could be a different color, e.g., red.

With a two light verification system 20 an operator can tell that verification has been started, that the same item was scanned multiple times, and that the order is correctly or incorrectly grouped together. These features of the verification system 20 allows an operator to pause a verification operation and resume the verification operation at a later time.

The operator keeps scanning until the grouped order is completed. The verification system 20 stores each of the unique_ID's scanned. The verification system 20 seeks to find 58 the piece having a number that is greater than fifty, i.e., the first piece. Until the verification system 20 finds the first piece, and decodes the encoded ID, it will not know how many pieces are in the order.

Once the process 50 finds the piece with the number greater than fifty, the process 50 takes that number and converts it into the number of pieces in the order by subtracting fifty from the number. Thus using a two digit sequence number the maximum number of items that can be tracked is 50. However, larger digit sequence numbers could be used, e.g., three digits in which case 500 articles could be tracked and so forth.

The verification system 20 could also include a monitor 26 (FIG. 1) that produces a screen display. The computer screen could display a current status. The display could give a listing of all of the pieces that were scanned, and once the first piece, e.g., the piece with the encoded sequence_ID, was scanned the verification system 20 could tell how many articles are left and how many unique pieces are left to scan.

In one operating scenario, the operator could use a wireless scanner and move around the dry cleaning establishment 10 verifying grouped orders. Thus, with the wireless scanner the verification system 20 could scan all of the garment tags 23 that are attached to an order or the clothes could be brought to a standard scanner and the garment tags 23 could be scanned there.

The verification process 40 can take place either at the time of bagging or at racking. Since the process 40 operates on grouped orders, if performed at the bagging station 18 it is used as a final check. If the garment tags 23 have been removed from the garments and are stapled to the invoice, which a number of dry cleaning establishments do, prior to putting the assembled order together and placing it on a conveyor, the order could be verified by scanning the garment tags 23. Once the order is on conveyor, after verification it can be assumed that the order is correct.

The verification process 40 was described using a temporary, e.g., paper tag with unique sequential identification numbers affixed to garments. However, with minor modifications, the verification process 40 could be adapted to work with permanent tags affixed to or within garments. The verification process 40 could be modified. The permanent tags would be initially scanned at order receipt. The numbers on the permanent tags would be associated with a group number and that group number would be printed on temporary tags affixed to the articles or simple printed on an invoice without the temporary tags.

Alternatively, the numbers from the permanent tags would be associated together in a database with all of the numbers scanned from the permanent tags of a particular order. The number of articles in the group would also be entered at drop off. This information would be stored in a database which could be accessed during the verification process.

During the verification process, an access to the database would be made in order to retrieve the number of articles in the group. The verification process would be modified to match numbers from the permanent labels on the articles to either the group number or the permanent numbers associated with the permanent tags. The system would continue to count these numbers until it matched the number of articles in the order which was obtained by an access to the database. The verification process would also indicate whether a scanned number did not correspond to the group number or did not correspond to one of the permanent numbers associated with the permanent tags of the order.

This invention offers value to dry cleaning establishments of all sizes, i.e., large or small. The verification system 20 verifies that the order that was correctly grouped together either through a manual grouping or an automated grouping process. For example, in a manual process it is possible that a person could misplace or mis-group an item in a group and still have the correct number of pieces. Even with an automated grouping process, there is nothing to prevent a person from placing an item of an order at the wrong assembly station. Also, an article could be knocked off an assembly hook, someone picks it up and puts it in the wrong location. There are many ways that the operator of a manual or automated grouping system can make a mistake. Also sometimes, just before bagging, the operator may notice that there is a spot or stain on a garment requiring additional finishing work. The finishing work could take place and the garment may be place on the wrong assembly hook.

The verification system 20 verifies correct grouping of articles in an order, rather than assembling articles into a group. Thus, this verification system 20 can prevent the occasional error that occurs. For example with manual assembly, maybe an dry cleaning establishment 10 would have one or two errors a week while process three or four thousand pieces. While the number are errors are small, these errors could be costly to the business because with such an error the business may have alienated a customer and may be liable to replace an expensive article of clothing. With this verification system 20 for a very small amount of time that it takes to verify, the dry cleaning establishment 10 can be confident that everything in that order belongs to that order.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1-26. (canceled)

27. A method of inventory management to indicate that a physically grouped order is ready for pickup by a customer, the method comprises:
verifying after cleaning at a dry cleaning facility that articles received from the dry cleaning facility were correctly grouped by a manual or automated grouping process into a physically grouped order belong to the physically grouped order by the steps comprising:
scanning unique identifier codes on tags associated with each one of the articles in the group; and
determining that each one of the articles in the group correctly belongs in the grouped order by positively indicating to an operator if any one of the scanned unique identifier codes associated with the articles does not correspond to an article that belongs in the grouped order.

28. The method of claim 27 wherein scanning further comprises:
scanning the tags using a machine readable code device.

29. The method of claim 27 wherein the method is conducted in a dry cleaning establishment that receives a plurality of different lots of physically grouped orders from the dry cleaning facility.

30. The method of claim 27 wherein the identifier codes include information about the invoice, number of articles in the grouped order, and code includes a unique identifier that uniquely identifies each article in the order in a machine readable format.

31. The method of claim 27 further comprising:
indicating to an operator using a different indicator if the scanned unique sequential identification corresponds to an item that belongs in the group.

32. The method of claim 27 wherein the method occurs at a single verification station that operates on a single order at a time.

33. The method of claim 32 wherein positively indicating to an operator if the scanned unique sequential code does not correspond to an item that belongs in the grouped order comprises:
positively indicating to an operator using a first indicator at the single verification station, and the method further comprises:
indicating to an operator using a second different indicator at the single verification station if the scanned unique sequential identification corresponds to an item that belongs in the group.

34. The method of claim 33 wherein examining
indicating to an operator using a third indicator if the scanned unique sequential identification corresponds to an item that was already scanned and that belongs in the group.

35. The method of claim 33 wherein examining further comprises:
determining if the scanned unique sequential identification corresponds to a first item that belongs in the group.

36. The method of claim 35 wherein after the first item has been determined, the method further comprises:
determining a total number of articles in the group from the unique sequential identification of the first item, without obtaining data from a database of information of stored orders for the dry cleaning establishment.

37. The method of claim 35 wherein determining further comprises:
subtracting a base number from a portion of the unique sequential identification to provide the number of items in the group.

38. The method of claim 27 wherein the unique sequential identification includes a group identification portion and a sequential number concatenated to the group identification portion.

39. The method of claim 27 wherein the unique sequential identification includes a code that includes a group_ID, a sequence_ID, and a machine readable bar code that encodes both the group_ID and the sequence_ID.

40. The method of claim 27 wherein the unique sequential identification is embodies as a bar code, touch memory device, a radio frequency device or an optical character recognition format device.

41. The method of claim 27 wherein the unique sequential identification is carried by a garment tag that is a permanent label, a put on/take off reusable label or a one-time use label.

42. A computer program product residing on a computer readable media for verifying that articles, which were physically grouped by a manual or automated grouping process into a physically grouped order, belong to the physically grouped order, comprises instructions for causing a computer to:
read unique identification codes on tags affixed to the articles, each tag associated with one article in the group;
determine if each of the unique identification codes corresponds to an item that belongs in the group; for each unique identification code
if the scanned unique identification code does not correspond to an item that belongs in the group,
indicate to an operator that the unique identification code does not correspond to an item that belongs in the grouped order;
if the unique identification code does correspond to an item that belongs in the group, and the first item in the group was not scanned
determine if the unique identification code corresponds to a first item that belongs in the group; if the unique identification code does corresponds to the first item,
subtract a base number from a portion of the unique sequential identification of a first item in the group to provide the total number of items in the group; otherwise store the unique identification codes that belong to items in the group;
determine when the last item in the group was scanned, by determining that all of the unique identification codes were read; and
indicate to an operator that verification is completed.

43. The computer program product of claim 42 wherein the unique identification code includes a group_ID, a sequence_ID, and a machine readable bar code that encodes both the group_ID and the sequence_ID.

44. The computer program product of claim 42 wherein instructions to examine further comprise instructions to:
indicate to an operator if the unique identification code corresponds to an item that was already scanned and that belongs in the group.

45. The computer program product of claim 42 wherein a group_ID and a sequence_ID are concatenated to provide the unique identification code.

46. An apparatus for verifying inventory grouping comprises:
a scanner to scan codes on labels;
a computer having a computer readable storage media storing a computer program product comprises instructions for causing the computer to:
read unique identification codes on tags affixed to the articles, each tag associated with one article in the group;
determine if each of the unique identification codes corresponds to an item that belongs in the group; for each unique identification code
if the scanned unique identification code does not correspond to an item that belongs in the group,
indicate to an operator that the unique identification code does not correspond to an item that belongs in the grouped order;
if the unique identification code does correspond to an item that belongs in the group, and the first item in the group was not scanned
determine if the unique identification code corresponds to a first item that belongs in the group; if the unique identification code does corresponds to the first item,
subtract a base number from a portion of the unique sequential identification of a first item in the group to provide the total number of items in the group; otherwise store the unique identification codes that belong to items in the group;
determine when the last item in the group was scanned, by determining that all of the unique identification codes were read; and
indicate to an operator that verification is completed.

47. The apparatus of claim 46 further comprising:
a printer to print tags having the unique identification code including a group_ID, a sequence_ID, and a machine readable bar code that encodes the group_ID and the sequence_ID, for affixing to the articles and/or a ticket or an invoice.

48. The apparatus of claim 46 further comprising:
an indicator to indicate to an operator that the verification process has started.

49. The apparatus of claim 46 further comprising:
an indicator to indicate to an operator that the verification process has ended successfully.

50. The apparatus of claim 46 further comprising:
an indicator to indicate to an operator that the verification process has ended unsuccessfully.
